(19) United States
(12) Patent Application Publication
(10) Pub. No.: US 2006/0208825 A1
(43) Pub. Date: Sep. 21, 2006

(54) Transmission line transition

(75) Inventor: Kouichirou Takahashi, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 11/374,126

(22) Filed: Mar. 14, 2006

(30) Foreign Application Priority Data
Mar. 15, 2005 (JP) 2005-073190

(51) Int. Cl. H01P 5/107

(52) U.S. Cl. 333/26; 333/33

(57) ABSTRACT

A first dielectric substrate 1 has an electromagnetically coupling conductor for a coplanar strip transmission line 4 disposed on a surface close to a dielectric layer 7, a second dielectric substrate 2 has a grounding conductor 12 disposed on a surface close to the dielectric layer, the grounding conductor 12 has an electromagnetic coupling slot 5 formed in a substantially H-character shape therein, and the second dielectric substrate 2 has an electromagnetically coupling conductor 10 for a microstrip transmission line disposed on a surface remote from the dielectric layer 7 so as to pass over or under the connecting slot 5.

### TECHNICAL FIELD OF THE INVENTION

The present invention relates to a transmission line transition, which is suited for a communication system using a microwave or millimeter wave band, and which is capable of making conversion from a microstrip transmission line to a coplanar strip transmission line or from a conductor for a coplanar strip transmission line to a microstrip transmission line.

### BACKGROUND OF THE INVENTION

Coplanar strip transmission lines have been generally utilized as transmission lines, which feed a signal to a planar antenna or transmit a signal received by a planar antenna when the planar antenna is utilized for communication using a microwave or millimeter-wave band.

A transmission line transition, which has been utilized to make conversion from a microstrip transmission line to a slot transmission line possible and conversion from the slot transmission line to a coplanar strip transmission line possible, is shown in FIG. 6. In the example shown in FIG. 6, a first dielectric substrate 21 has an electromagnetically coupling conductor 24 for a coplanar strip transmission line disposed in a substantially dew-shaped form thereon, and the first dielectric substrate 21, a dielectric layer 27, a grounding conductor 26 and a second dielectric substrate 22 are laminated in this order. The second dielectric substrate 22 has the grounding conductor 26 disposed on a surface thereof close to the dielectric layer 27, and the grounding conductor 26 has a linear slot 25 formed therein. The second dielectric substrate 22 has an electromagnetically coupling conductor 20 for a microstrip line disposed on a surface thereof remote from the dielectric layer 27. All parts in the example shown in FIG. 6 except for the second dielectric substrate 22 and the electromagnetically coupling conductor 20 for a microstrip line are disclosed in “Microstrip Lines and Slotlines”, Second Edition, p. 440-441, 7.7.5 CPS-to-Slotline Transitions, coauthored by K. C. Gupta, Ramesh Garg, Inder Bahl, Prakash Bhartia. However, there has been a problem that a transmission line transition, which partly utilizes the prior art, is not suitable for miniaturization.

Additionally, the above-mentioned prior art reference is silent on specific dimensions of the electromagnetically coupling conductor 24 for a coplanar strip transmission line and the like.

### SUMMARY OF THE INVENTION

It is an object of the present invention to solve the above-mentioned problems involved in the prior art and to provide a novel transmission line transition.

The present invention provides a transmission line transition comprising:
a first dielectric substrate;
a second dielectric substrate spaced from the first dielectric substrate;
a dielectric layer interposed between the first dielectric substrate and the second dielectric substrate;
the first dielectric substrate having a pair of conductors for a coplanar strip transmission line and an electromagnetically coupling conductor for the coplanar strip transmission line disposed on a surface close to the dielectric layer;
the electromagnetically coupling conductor for the coplanar strip transmission line being formed in a semi-loop shape with a discontinuity partly formed therein;
respective portions of the electromagnetically coupling conductor for the coplanar strip transmission line, which are located at both ends of the discontinuity or in the vicinity of both ends of the discontinuity, being connected to respective ends of the paired conductors for the coplanar strip transmission line or portions of the paired conductors in the vicinity of the respective ends of the paired conductors, the paired conductors extending toward a direction to be apart from the electromagnetically coupling conductor;
the semi-loop shape being a rectangular shape or a substantially rectangular shape;
the second dielectric substrate having a grounding conductor disposed on a surface close to the dielectric layer, the grounding conductor having a first slot and a second slot formed therein so as to be parallel or substantially parallel to each other;
the grounding conductor further having a connecting slot formed therein so as to connect between the first slot and the second slot so that the first slot, the second slot and the connecting slot form an electromagnetic coupling slot in an H-character shape or substantially H-character shape;
the electromagnetic coupling slot being disposed so that the connecting slot intersects a longitudinal direction of the rectangular shape or the substantially rectangular shape of the semi-loop shape as viewed in a plan view; and
the second dielectric substrate having an electromagnetically coupling conductor for a microstrip transmission line disposed on a surface remote from the dielectric layer so as to pass over or under the connecting slot.

The present invention also provides a transmission line transition comprising:
a first dielectric substrate;
a second dielectric substrate spaced from the first dielectric substrate;
a dielectric layer interposed between the first dielectric substrate and the second dielectric substrate;
the first dielectric substrate having a pair of conductors for a coplanar strip transmission line and an electromagnetically coupling conductor for the coplanar strip transmission line disposed on a surface close to the dielectric layer;
the electromagnetically coupling conductor for the coplanar strip transmission line being formed in a semi-loop shape with a discontinuity partly formed therein;
respective portions of the electromagnetically coupling conductor for the coplanar strip transmission line, which are located at both ends of the discontinuity or in the vicinity of both ends of the discontinuity, being connected to respective ends of the paired conductors for the coplanar strip transmission line or portions of the paired conductors in the vicinity of the respective ends of the paired conductors, the paired conductors extending toward a direction to be apart from the electromagnetically coupling conductor;
the semi-loop shape being a square shape or a substantially square shape;
the second dielectric substrate having a grounding conductor disposed on a surface close to the dielectric layer, the grounding conductor having a first slot and a second slot formed therein so as to be parallel or substantially parallel to each other;
the grounding conductor further having a connecting slot formed therein so as to connect between the first slot and the second slot so that the first slot, the second slot and the connecting slot form an electromagnetic coupling slot in an H-character shape or substantially H-character shape;
the electromagnetic coupling slot being disposed so that a portion of the connecting slot extending in a longitudinal direction passes over or under a side of the electromagnetically coupling conductor for the coplanar strip transmission line remote from the discontinuity; and
the second dielectric substrate having an electromagnetically coupling conductor for a microstrip transmission line disposed on a surface remote from the dielectric layer so as to pass over or under the connecting slot.

In accordance with the present invention, the electromagnetically coupling conductor for a coplanar strip transmission line is formed in a semi-loop shape with a discontinuity formed therein, and the respective portions of the electromagnetically coupling conductor for the coplanar strip transmission line, which are located at both ends of the discontinuity or in the vicinity of both ends of the discontinuity, are connected to the respective ends of the paired conductors for the coplanar strip transmission line or portions of the paired conductors for the coplanar strip transmission line in the vicinity of the respective ends of the paired conductors. When the semi-loop shape is a rectangular shape or a substantially rectangular shape, the transmission line transition can be made compact by 8.5 to 61% in comparison with the prior art.

When the semi-loop shape is a square shape or a substantially square shape, the transmission line transition can be made compact by 20 to 30% in comparison with the prior art.

The present invention can utilize the above-mentioned structure to realize transmission line conversion and impedance matching between the microstrip transmission line and the coplanar strip transmission line. Additionally, the present invention has an advantage of being capable of fabricating a transmission line transition at a low cost by a simple structure.

When a transmission line transition according to the present invention is utilized as a planar antenna transmission line, which is disposed at the front windshield or the rear windshield of an automobile, it is possible to effectively produce a high frequency antenna. In particular, it is possible to fabricate a high frequency antenna, which is suited for SDARS (Satellite Digital Audio Radio Service for about 2.6 GHz), GPS (Global Positioning System), VICS (Vehicle Information and Communication System), ETC (Electronic Toll Collection System), DSRC (Dedicated Short Range Communication) system and the like.

### BRIEF DESCRIPTION OF THE DRAWINGS

For a more complete understanding of the present invention and the advantages thereof, reference is now made to the following description taken in conjunction with the accompanying drawings, wherein like reference numbers represent like parts, and which:

FIG. 1 is a schematic view showing the transmission line transition according to an embodiment of the present invention;

FIG. 2 is a plan view showing an electromagnetic coupling slot and an electromagnetic coupling conductor for a microstrip line in the embodiment;

FIG. 3 is a plan view showing the electromagnetic coupling conductor for the microstrip line and an electromagnetic coupling conductor for a coplanar strip transmission line in the embodiment;

FIG. 4 is a plan view showing the electromagnetic coupling conductor for the coplanar strip transmission line in the embodiment;

FIG. 5 is a frequency characteristic graph in an Example;

FIG. 6 is a schematic view showing a transmission line transition utilizing a conventional electromagnetically coupling conductor for a coplanar strip transmission line;

FIG. 7 is a plan view showing an electromagnetic coupling conductor for a coplanar strip transmission line, according to another embodiment, which is different from the embodiment shown in FIGS. 1 and 4;

FIG. 8 is a plan view for explanation of L_{offx1};

FIG. 9 is a plan view for explanation of L_{offx2};

FIG. 10 is a plan view for explanation of L_{offy} wherein the value of L_{offy} is positive;

FIG. 11 is a plan view for explanation of L_{offy} wherein the value of L_{offy} is negative;

FIG. 12 is a characteristic graph for L_{offx1} or L_{offx2} to insertion loss in Example 2;

FIG. 13 is a characteristic graph for L_{offy} to insertion loss in Example 3;

FIG. 14 is a characteristic graph for length L₅ to insertion loss in Example 4; and

FIG. 15 is a plan view showing an electromagnetic coupling conductor for a microstrip line and an electromagnetic coupling conductor for a coplanar strip transmission line according to another embodiment, which is different from the embodiments shown in FIGS. 8, 9, 10 and 11.

### DETAILED DESCRIPTION OF THE INVENTION

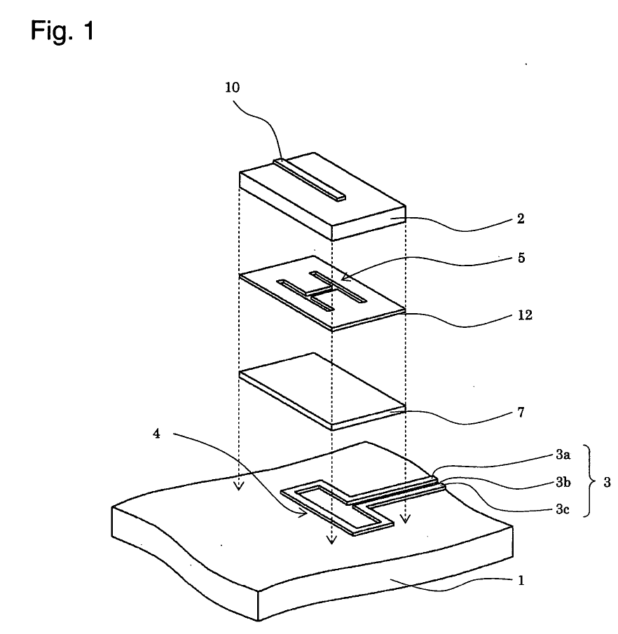

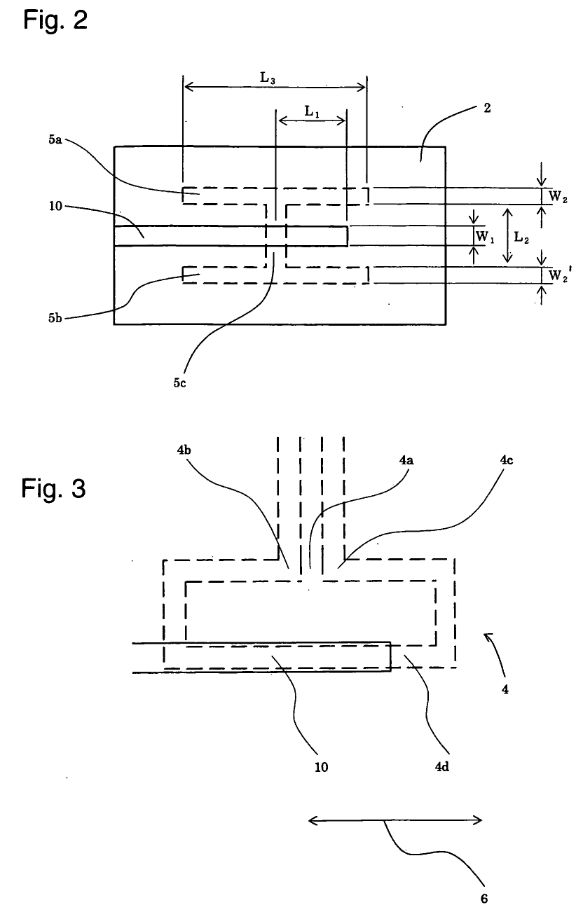

Now, a transmission line transition according to the present invention will be described based on preferred embodiments shown in the accompanying drawings. FIG. 1 is a schematic view showing the transmission line transition according to one embodiment of the present invention, FIG. 2 is a plan view showing an electromagnetic coupling slot 5 and an electromagnetic coupling conductor 10 for a microstrip line in the embodiment shown in FIG. 1, and FIG. 3 is a plan view showing the electromagnetic coupling conductor 10 for the microstrip line and an electromagnetic coupling conductor 4 for a coplanar strip transmission line in the embodiment shown in FIG. 1.

In FIGS. 1, 2 and 3, reference numeral 1 designates a first dielectric substrate, reference numeral 2 designates a second dielectric substrate, reference numeral 3 designates a pair of conductors for the coplanar strip transmission line, reference numeral 3a designates a first conductor for the coplanar strip transmission line, reference numeral 3b designates a gap for the coplanar strip transmission line, which is disposed between the paired conductors for the coplanar strip transmission line, reference numeral 3c designates a second conductor for the coplanar strip transmission line, reference numeral 4 designates the electromagnetically coupling conductor for the coplanar strip transmission line, reference numerals 4b and 4c designate portions of the electromagnetically coupling conductor for the coplanar strip transmission line, which are located at both ends of a discontinuity 4a or in the vicinity of both ends of the discontinuity, reference numeral 4d designates a side of the electromagnetically coupling conductor for the coplanar strip transmission line, which is remote from the discontinuity, reference numeral 5 designates the electromagnetically coupling slot, which is formed in an H-character shape or a substantially H-character shape, reference numeral 5a designates a first slot, reference numeral 5b designates a second slot, reference numeral 5c designates a connecting slot, reference numeral 6 designates arrows showing the longitudinal direction of a semi-loop shape of the electromagnetically coupling conductor 4 for the coplanar strip transmission line, reference numeral 7 designates a dielectric layer, reference numeral 10 designates the electromagnetic coupling conductor for the microstrip line, reference numeral 12 designates a grounding conductor, reference L₁ designates the distance between the center of the connecting slot 5c and an open end of the electromagnetic coupling conductor 10 for the microstrip line, reference L₂ designates the length of the connecting slot 5c, reference L₃ designates the length of the first slot, reference W₁ designates the conductor width of the electromagnetic coupling conductor 10 for the microstrip line, reference W₂ designates the width of the first slot 5a, and reference W₂′ designates the width of the second slot 5b.

In the embodiment shown in FIG. 1, all parts shown in FIG. 1 are laminated so as to be put one after the other in the direction of arrows.

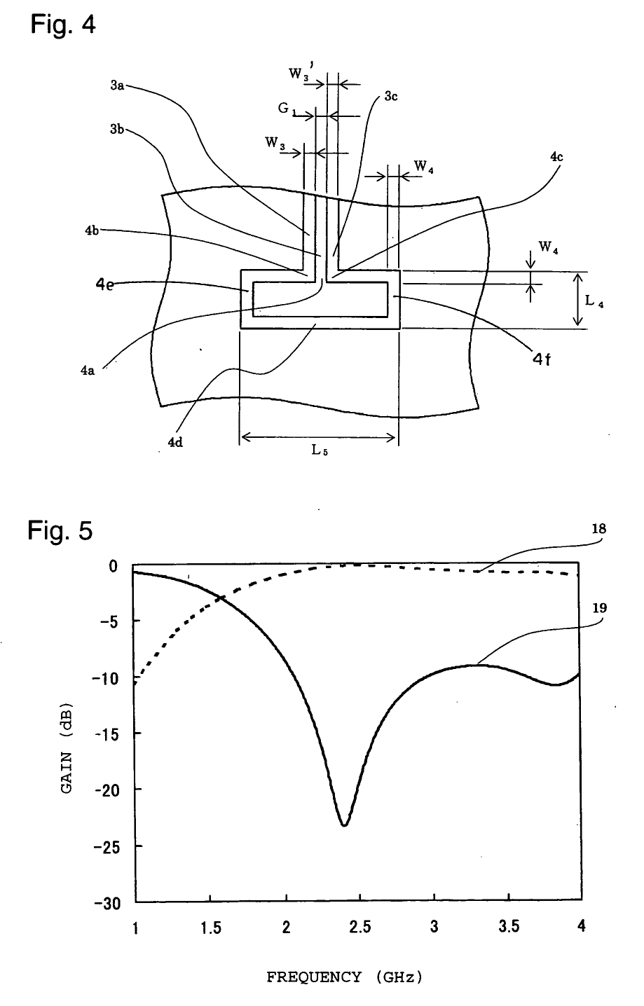

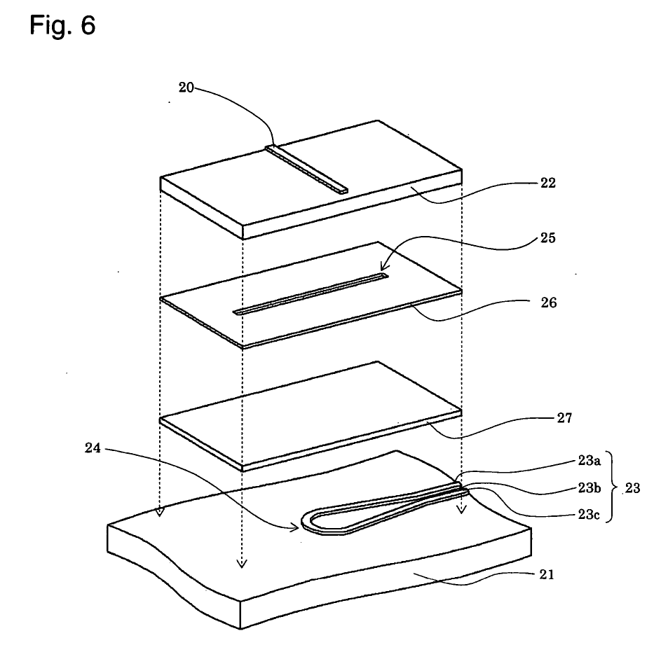

FIG. 4 is a plan view of the electromagnetically coupling conductor 4 for the coplanar strip transmission line in the embodiment shown in FIG. 1. In FIG. 4, reference G₁ designates the distance between the first conductor 3a for the coplanar strip transmission line and the second conductor 3c for the coplanar strip transmission line, reference L₄ designates the length of a short side of the electromagnetically coupling conductor 4 for the coplanar strip transmission line, reference L₅ designates the length of a long side of the electromagnetically coupling conductor 4 for the coplanar strip transmission line, W₃ designates the conductor width of the first conductor 3a for the coplanar strip transmission line, reference W₃, designates the conductor width of the second conductor 3c for the coplanar strip transmission line, and reference W₄ designate the conductor width of the electromagnetically coupling conductor 4 for the coplanar strip transmission line.

The transmission line transition according to the present invention comprises the first dielectric substrate 1, the second dielectric substrate 2 disposed so as to be spaced from the first dielectric substrate 1, and the dielectric layer 7 disposed between the first dielectric substrate 1 and the second dielectric substrate 2. The first dielectric substrate 1 has the paired conductors 3 for the coplanar strip transmission line and the electromagnetically coupling conductor 4 for the coplanar strip transmission line disposed on a surface thereof close to the dielectric layer 7. The electromagnetically coupling conductor 4 for the coplanar strip transmission line is formed in a semi-loop shape with the discontinuity 4a formed therein. In the present invention, the semi-loop shape means an incomplete loop shape wherein the loop has a discontinuity partly formed therein.

The portions 4b and 4c of the electromagnetically coupling conductor 4 for the coplanar strip transmission line, which are located at both ends of the discontinuity 4a or in the vicinity of both ends of the discontinuity, are connected to respective ends of the paired conductors 3 of the coplanar strip transmission line or portions of the paired conductors 3 in the vicinity of the respective ends of the paired conductors 3. The paired conductors for the coplanar strip transmission line extend in a direction to be apart from the electromagnetically coupling conductor 4 for the coplanar strip transmission line.

In the present invention, it is preferred from the viewpoint of improving transmission efficiency that the conductor width W₃ of the first conductor 3a for the coplanar strip transmission line be the same or substantially the same as the conductor width W₃′ of the second conductor 3c for the coplanar strip transmission line. It is also preferred that the conductor width W₃ of the first conductor 3a for the coplanar strip transmission line and the conductor width W₃′ of the second conductor 3c for the coplanar strip transmission line be narrower than the conductor width W₄ of the electromagnetically coupling conductor 4 for the coplanar strip transmission line. Further, it is more preferred that the following conditions be satisfied.
Conductor width W₃≦0.6×conductor width W₄, and
Conductor width W₃′0.6×conductor width W₄

In the embodiment shown in FIGS. 1 and 3, the semi-loop shape of the electromagnetically coupling conductor 4 for the coplanar strip transmission line is a rectangular shape or a substantially rectangular shape, and the longitudinal direction of the rectangular shape or the substantially rectangular shape intersects the extension direction of portions of the paired conductors 3 for the coplanar strip transmission line, which are located in the vicinity of the discontinuity 4a. It is preferred from the viewpoint decreasing insertion loss and improving transmission efficiency that the semi-loop shape be a rectangular shape or a substantially rectangular shape. However, the semi-loop shape is not limited to have a such a shape. Even if the semi-loop shape is a square shape or a substantially square shape, the present invention is operable. It should be noted that the longitudinal direction of the semi-loop shape of the electromagnetically coupling conductor 4 for the coplanar strip transmission line accords with the longitudinal direction of the side 4d of the electromagnetically coupling conductor 4 for the coplanar strip transmission line, which is remote from the discontinuity.

The second dielectric substrate 2 has the grounding conductor 12 disposed on a surface thereof close to the dielectric layer 7, and the grounding conductor 12 has the first slot 5a and the second slot 5b formed therein so as to be parallel or substantially parallel to each other. The grounding conductor 12 additionally has the connecting slot 5c formed therein to connect the first slot 5a and the second slot 5b, and the first slot 5a, the second slot 5b and the connecting slot 5c form the electromagnetically coupling slot 5 in an H-character shape or a substantially H-character shape.

In the embodiments shown in FIGS. 8, 9 and 10 stated later, the electromagnetically coupling slot 5 is disposed in such a direction that a portion of the electromagnetically coupling slot 5 overlaps with the electromagnetically coupling conductor 4 for the coplanar strip transmission line as viewed in a plan view and that the connecting slot 5c passes over or under a portion of the rectangular or substantially rectangular semi-loop shape extending in the longitudinal direction. The connecting slot 5c orthogonally or substantially orthogonally passes over or under the side 4d of the electromagnetically coupling conductor 4 for the coplanar strip transmission line, which is remote from the discontinuity.

The second dielectric substrate 2 has the electromagnetically coupling conductor 10 for the microstrip line disposed on a surface remote from the dielectric layer 7 so as to pass over or under the connecting slot 5c. In the embodiment shown in FIG. 1, the angle, at which the connecting slot 5c and the electromagnetically coupling conductor 10 for the microstrip line intersect each other as viewed a plan view, is a right angle or a substantially right angle. This arrangement is preferred to improve transmission efficiency. However, the present invention is not limited to have this arrangement. The present invention is operable even if the angle formed by the connecting slot 5c and the electromagnetically coupling conductor 10 for the microstrip line is not a right angle or a substantially right angle.

When it is assumed that an imaginary straight line extends in a direction perpendicular to the first dielectric substrate 1 and passes through the center of the connecting slot 5c, and when the center of the connecting slot 5c is viewed from the imaginary straight line, it is preferred from the viewpoint of improving transmission efficiency that the point where the connecting slot 5c and the electromagnetically coupling conductor 10 for the microstrip line intersect each other overlap or substantially overlap with the center of the connecting slot 5c.

When it is assumed that the imaginary straight line extends in the direction perpendicular to the first dielectric substrate 1 and passes through the center of the connecting slot 5c, and when the center of the connecting slot 5c is viewed from the imaginary straight line, it is preferred from the viewpoint of improving transmission efficiency that the center of the connecting slot 5c overlap or substantially overlap with the side 4d of the electromagnetically coupling conductor 4 for the coplanar strip transmission line.

When it is assumed that the imaginary straight line extends in the direction perpendicular to the first dielectric substrate 1 and passes through the center of the connecting slot 5c, and when the center of the connecting slot 5c is viewed from the imaginary straight line, it is preferred from the viewpoint of improving transmission efficiency that the center of the connecting slot 5c overlap or substantially overlap with the center of the side 4d of the electromagnetically coupling conductor 4 for the coplanar strip transmission line.

As stated above, it is preferred from the viewpoint of improving transmission efficiency that a portion of the electromagnetically coupling slot 5 overlap with the electromagnetically coupling conductor 4 for the coplanar strip transmission line as viewed in such a plan view. However, the present invention is not limited to have this arrangement. The present invention is operable even if all portions of the electromagnetically coupling slot 5 are disposed inside an inner peripheral edge of the electromagnetically coupling conductor 4 for the coplanar strip transmission line (FIG. 15).

In the embodiment shown in FIGS. 1 and 4, in a case wherein the electromagnetically coupling conductor 4 for the coplanar strip transmission line has a certain conductor width, when it is assumed that the electromagnetically coupling conductor 4 for the coplanar strip transmission line has no discontinuity 4a formed therein, and that the electromagnetically coupling conductor 4 for the coplanar strip transmission line is disposed so as to be continuous at the portion with the shown discontinuity 4a; the electromagnetically coupling conductor 4 for the coplanar strip transmission line thus assumed has an outer peripheral edge and an inner peripheral edge formed in a square or substantially square shape, respectively.

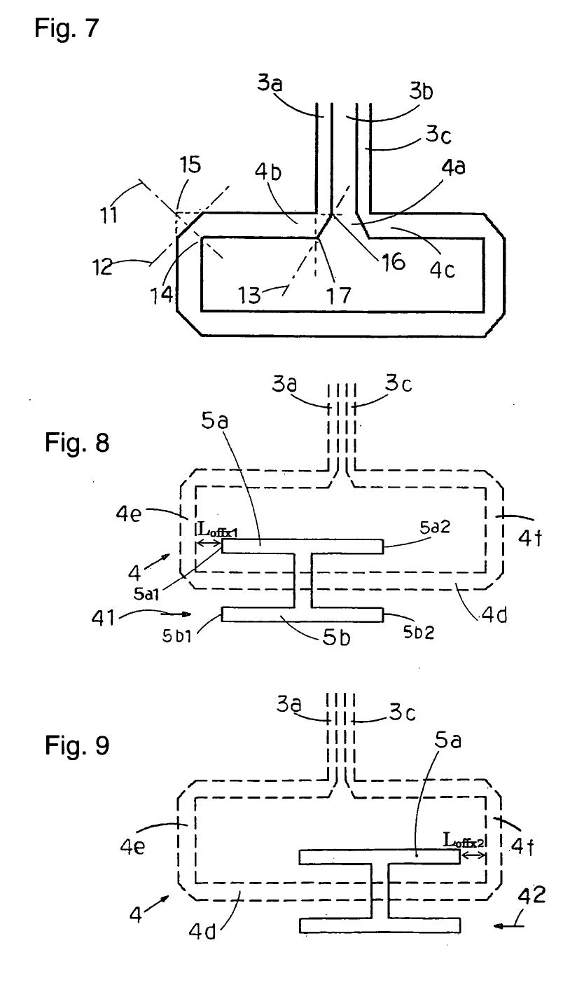

The electromagnetically coupling conductor 4 for the coplanar strip transmission line according another embodiment, which is different from the embodiment shown in FIGS. 1 and 4, is shown in FIG. 7. In the embodiment shown in FIG. 7, in a case wherein the respective four apexes of the four corners of the square shape or the substantially square shape defined by the outer peripheral edge of the electromagnetically coupling conductor 4 for the coplanar strip transmission line are called outer peripheral apexes, wherein the respective four apexes of the four corners of the square shape or the substantially square shape defined by the inner peripheral edge of the electromagnetically coupling conductor for the coplanar strip transmission line are called inner peripheral apexes, and wherein explanation is made about an outer peripheral apex 15 as an example, which is located at an upper left position in FIG. 7; when it is assumed that a first imaginary straight line connects between the outer peripheral apex 15 and an inner peripheral apex 14 closest to the outer peripheral apex 15, when the first imaginary straight line is called a first imaginary line 11, when it is assumed that a second imaginary straight line extends orthogonally or substantially orthogonally to the first imaginary line 11 and passes through the center or a position in the vicinity of the center between the outer peripheral apex 15 and the inner peripheral apex 14, and when the second imaginary straight line is called a second imaginary line 12, a portion of the electromagnetically coupling conductor 4 for the coplanar strip transmission line, which is located outside the second imaginary line, is cut out, forming a cut-out portion.

It is preferred that each of all four outer peripheral apexes have a cut-out portion formed therein as in the embodiment shown in FIG. 7. However, the present invention is not limited to have this arrangement. The present invention is operable as long as at least one of the four outer peripheral apexes has a cut-out portion.

In the embodiment shown in FIG. 7, when it is assumed that an outer peripheral edge of the portion 4b of the electromagnetically coupling conductor 4 for the coplanar strip transmission line, which is close to the first conductor 3a for the coplanar strip transmission line and forms one of both end portions of the electromagnetically coupling conductor 4 for the coplanar strip transmission line at both ends of the discontinuity 4a, is linearly extended toward a central portion of the discontinuity, when a point where the extended outer peripheral edge intersects an inner peripheral edge of the first conductor 3a for the coplanar strip transmission line is called a first intersection 16, when it is assumed that an outer peripheral edge of the first conductor 3a for the coplanar strip transmission line is linearly extended toward the central portion of the electromagnetically coupling conductor 4 for the coplanar strip transmission line, and that a point where the extended outer peripheral edge of the first conductor intersects the inner peripheral edge of the electromagnetically coupling conductor 4 for the coplanar strip transmission line is called a second intersection 17, when it is assumed that a third imaginary straight line connects between the first intersection 16 and the second intersection 17, and when the imaginary straight line is called a third imaginary line 13; a portion of the electromagnetically coupling conductor 4 for the coplanar strip transmission line or the first conductor 3a for the coplanar strip transmission line, which is closer to the central portion of the electromagnetically coupling conductor 4 for the coplanar strip transmission line than the third imaginary straight line, is cut out, forming a cut-out portion (a first inner cut-out portion).

The outer peripheral edge of the first conductor 3a for the coplanar strip transmission line means a peripheral edge of the first conductor 3a for the coplanar strip transmission line, which is remote from the gap 3b for the coplanar strip transmission line. The inner peripheral edge of the first conductor 3a for the coplanar strip transmission line means a peripheral edge of the first conductor 3a for the coplanar strip transmission line, which is close to the gap 3b for the coplanar strip transmission line.

Additionally, in the embodiment shown in FIG. 7, when it is assumed that an outer peripheral edge of the portion 4c of the electromagnetically coupling conductor for the coplanar strip transmission line, which is close to the second conductor 3c for the coplanar strip transmission line and forms the other one of both end portions of the electromagnetically coupling conductor for the coplanar strip transmission line at both ends of the discontinuity 4a, is linearly extended toward the central portion of the discontinuity, when the point where the extended outer peripheral edge intersects an inner peripheral edge of the second conductor 3c for the coplanar strip transmission line is called a third intersection, when it is assumed that an outer peripheral edge of the second conductor 3b for the coplanar strip transmission line is linearly extended toward the central portion of the electromagnetically coupling conductor 4 for the coplanar strip transmission line, and that the point where the extended outer peripheral edge of the second conductor intersects the inner peripheral edge of the electromagnetically coupling conductor 4 for the coplanar strip transmission line is called a fourth intersection, when it is assumed that a fourth imaginary straight line connects between the third intersection and the fourth intersection, and when the fourth imaginary straight line is called a fourth imaginary line; a portion of the electromagnetically coupling conductor 4 for the coplanar strip transmission line or the second conductor for the coplanar strip transmission line, which is closer to the central portion of the electromagnetically coupling conductor 4 for the coplanar strip transmission line than the fourth imaginary straight line, is cut out, forming a cut-out portion (a second inner cut-out portion).

It is preferred that the electromagnetically coupling conductor 4 for the coplanar strip transmission line have both the first inner cut-out portion and the second inner cut-out portion formed therein as shown in FIG. 7. However, the present invention is not limited to have this arrangement. The present invention is operable even if the electromagnetically coupling conductor 4 for the coplanar strip transmission line has only one of the first inner cut-out portion and the second inner cut-out portion formed therein.

When the electromagnetically coupling conductor 4 for the coplanar strip transmission line has a short side length of L₄, and when the electromagnetically coupling conductor for the coplanar strip transmission line has a long side length L₅, it is preferred from the viewpoint of improving transmission efficiency that the formula of 0.11≦(L₄/L₅)<1.0, in particular 0.11≦(L₄/L₅)<0.65, be satisfied.

It is preferred from the viewpoint of improving transmission efficiency that the length L₃ of the first slot and the length of the second slot be the same or substantially the same as each other. However, the present invention is not limited to have this arrangement. The present invention is operable even if the length L₃ of the first slot and the length of the second slot are different from each other. It is preferred from the viewpoint of improving transmission efficiency that the length L₃ of the first slot of the length of the second slot be normally shorter than the length L₅.

It is preferred from the viewpoint of improving transmission efficiency that the width W₂ of the first slot 5a and the width W₂′ of the second slot 5b be from 0.1 to 1.0 mm, in particular from 0.2 to 0.6 mm. It is preferred from the viewpoint of improving transmission efficiency that the conductor width W₁ of the electromagnetically coupling conductor 10 of the microstrip line be from 1.0 to 2.0 mm, in particular from 1.3 to 1.6 mm. It is preferred from the viewpoint of improving transmission efficiency that the distance L₁ be from 3.0 to 15.0 mm, in particular from 5.0 to 10.0 mm.

In the present invention, when the operating frequency is from 1.95 to 2.93 GHz, it is preferred that the length L₅ of the side of the electromagnetically coupling conductor 4 for the coplanar strip transmission line, which is remote from the discontinuity 4a, be from 5.0 to 46.1 mm. The reason why the operating frequency is set at a value from 1.95 to 2.93 GHz is that the formula of (2.34/1.2)−(2.34/0.8) GHz ≈1.95−2.93 GHz is established, provided that a permission range of 20% is given to 2.34 GHz that is the frequency of SDARS in the United States. The permissible range is preferably from 2.13 to 2.6 GHz with a permission range of 10%, more preferably from 2.23 to 2.46 GHz with a permission range of 5%.

The length L₅ preferably ranges from 8.0 to 40.8 mm, more preferably ranges from 12.0 to 37.2 mm.

Under the condition of the above-mentioned operating frequency range, it is preferred that the length L₄ of two sides of the electromagnetically coupling conductor 4 for the coplanar strip transmission line, which are adjacent the side 4d opposite the discontinuity 4a, be from 5.0 to 46.1 mm. The length L₄ more preferably ranges from 8.0 to 40.8 mm, most preferably ranges from 12.0 to 37.2 mm.

FIGS. 8 and 9 are plan views for explanation of L_{offx1} and L_{offx2} stated later. Explanation of the following conditions will be made about a case wherein it is assumed that an imaginary straight line passes through the center of the gap 3b for the coplanar strip transmission line and extends toward the center of the electromagnetically coupling conductor 4 for the coplanar strip transmission line under the condition of the above-mentioned operating frequency range, and wherein the electromagnetically coupling conductor 4 for the coplanar strip transmission line is viewed, being divided into a portion close to the first conductor 3a for the coplanar strip transmission line and a portion close to the second conductor 3c for the coplanar strip transmission line with this imaginary straight line used as the boundary.

The inner edge of a side 4e of the electromagnetically coupling conductor 4 for the coplanar strip transmission line, which forms one of the two sides adjacent the side 4d opposite the discontinuity 4a and is close to the first conductor 3a for the coplanar strip transmission line, is called a first inner edge. The inner edge of a side 4f of the electromagnetically coupling conductor 4 for the coplanar strip transmission line, which forms the other one of the two sides adjacent the side 4d opposite the discontinuity 4a and is close to the second conductor 3c for the coplanar strip transmission line, is called a second inner edge.

When the leading edge of the first slot 5a, which is close to the first inner edge, is called a first leading edge 5a1 of the first slot; when the leading edge of the first slot 5a, which is close to the second inner edge, is called a second leading edge 5a2 of the first slot; when the leading edge of the second slot 5b, which is close to the first inner edge, is called a first leading edge 5b1 of the second slot; when the leading edge of the second slot 5b, which is close to the second inner edge, is called a second leading edge 5ab of the second slot; when a shorter one of the shortest distance between the first leading edge 5al of the first slot and the first inner edge, and the shortest distance between the first leading edge 5b1 of the second slot and the first inner edge is called L_{offx1}; and when a shorter one of the shortest distance between the second leading edge 5a2 of the first slot and the second inner edge, and the shortest distance between the second leading edge 5b2 of the second slot and the second inner edge is called L_{offx2}; it is preferred that the formulas of L_{offx1}≧−2 mm and L_{offx2}≧−2 mm are satisfied.

It is determined that the value of L_{offx1} is positive when the first leading edge 5al of the first slot approaches toward the center of the electromagnetically coupling conductor 4 for the coplanar strip transmission line in a direction (indicated by an arrow 41 in FIG. 8), which is parallel to the longitudinal direction of the side 4d of the electromagnetically coupling conductor 4 for the coplanar strip transmission line remote from the discontinuity 4a, and that the value of L_{offx1} is negative when the first leading edge 5al of the first slot recedes from the center in such a direction.

It is determined that the value of L_{offx2} is positive when the second leading edge 5a2 of the first slot approaches toward the center of the electromagnetically coupling conductor 4 for the coplanar strip transmission line in a direction (indicated by an arrow 42 in FIG. 9), which is parallel to the longitudinal direction of the side 4d of the electromagnetically coupling conductor 4 for the coplanar strip transmission line remote from the discontinuity 4a, and that the value of L_{offx2} is negative when the second leading edge 5a2 of the first slot recedes from the center in such a direction.

It is preferred that the values of L_{offx1} and L_{offx2} satisfy the formulas of L_{offx1}≧0 mm and L_{offx2}≧0 mm. It is particularly preferred that the values of L_{offx1} and L_{offx2} satisfy the formulas of L_{offx1}≧1 mm and L_{offx2}≧1 mm.

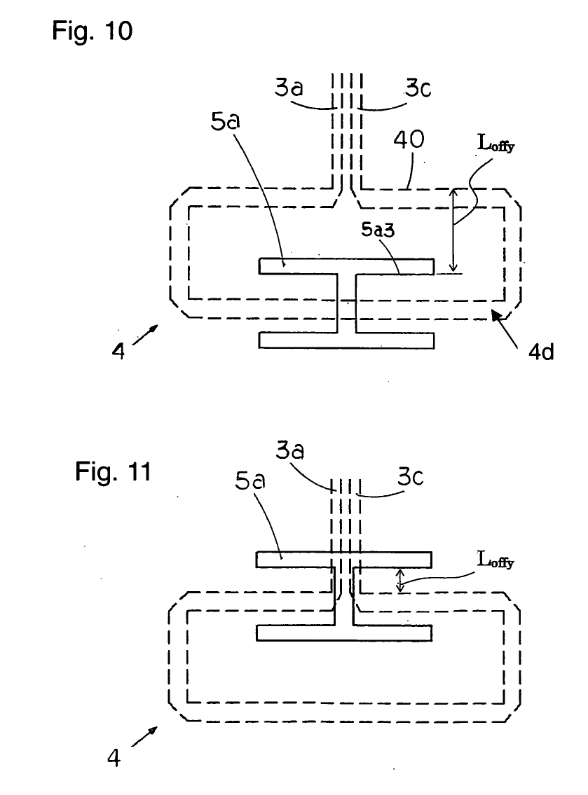

FIGS. 10 and 11 are plan views for explanation of L_{offy} stated later. In FIGS. 10 and 11, when the distance between an outer edge 40 of a side of the electromagnetically coupling conductor 4 for the coplanar strip transmission line close to the paired conductors 3 for the coplanar strip transmission line and an edge 5a3 of the first slot close to the connecting slot 5c is called L_{offy}, it is preferred that the formula of −4.3 mm ≦L_{offy}≦8.0 mm is satisfied.

It is determined that the value of L_{offy} is positive when the edge 5a3 of the first slot close to the connecting slot 4c is disposed so as to be close to the side 4d of the electromagnetically coupling conductor 4 for the coplanar strip transmission line remote from the discontinuity 4a with the outer edge 40 of the side of the electromagnetically coupling conductor 4 for the coplanar strip transmission line close to the paired conductors 3 for the coplanar strip transmission line used as the boundary (FIG. 10), and that the value of L_{offy} is negative when the edge 5a3 of the first slot is disposed so as to be close to the paired conductors 3 for the coplanar strip transmission line (FIG. 11).

The value of L_{offy} preferably satisfies the formula of −3.5 mm≦L_{offy}≦7.3 mm, particularly preferably satisfies the formula of 1.0 mm≦L_{offy}≦6.5 mm.

There is no particular limitation to the thickness of the first dielectric substrate 1 since the thickness of the first dielectric substrate is not directly related to electromagnetic coupling. For example, when the first dielectric substrate comprises an automobile windshield, it is preferred to use a glass sheet having a thickness of from 2.0 to 6.0 mm and a dielectric constant of (ε₁) of from 5.0 to 9.0 as in a normal automobile windshield.

When the first dielectric substrate 1 comprises an automobile windshield, it is preferred that the grounding conductor 12 have a peripheral edge spaced from the opening edge of an automobile body by a length of 1 mm or above. However, the present invention is not limited to have this arrangement. The present invention is operable even if the peripheral edge of the grounding conductor 12 is connected to the opening edge of an automobile body. In this case, the opening edge means a peripheral edge of an opening of an automobile body, into which a windshield is fitted, which serves as ground connection through the automobile body, and which is made of a conductive material, such as metal.

It is preferred that the second dielectric substrate 2 have dimensions (an area) of from 2.6×26.0 mm (67.6 mm²) to 15.0×31.0 mm (465 mm²). It is preferred from the viewpoint of improving transmission efficiency that the second dielectric substrate have a dielectric constant (ε₂) of from 1.0 to 8.0. The second dielectric substrate 2 may be normally a circuit board comprising a synthetic resin, ceramics or the like. It is preferred that the second dielectric substrate 2 have a thickness of from 0.1 to 6.0 mm. This is because it is easy to fabricate a substrate in such a thickness range in terms of production technique.

It is preferred that the dielectric layer 7 be interposed between the first dielectric substrate 1 and the second dielectric substrate 2 and have an insulating property. The dielectric layer 7 may normally comprise a dielectric composition containing, e.g., a synthetic resin, such as an adhesive or a filler, having an insulating property, or ceramics. The dielectric layer may comprise a gas layer. However, the present invention is not limited to have such arrangements. Any dielectric substance is applicable as the dielectric layer, and a dielectric substrate is also applicable as the dielectric layer.

An example of the adhesive having an insulating property is an adhesive containing an epoxy resin or the like. It is preferred to use an adhesive having a dielectric constant ranging from 1.0 to 4.0 since such an adhesive is easily available at a low cost. An example of the filler is a filler containing silicone having an insulating property.

When the dielectric layer 7 comprises a gas layer, an air layer is normally used because of being inexpensive. The present invention is not limited to use such an air layer. The gas layer may comprise an inert gas, such as nitrogen or argon. It is preferred that such a gas layer be sufficiently dried so as to prevent the moisture contained in the gas from being condensed according to temperatures.

It is preferred that the dimensions or area of the dielectric layer 7 be the same as the dimensions or area of the second dielectric substrate 2. It is preferred from the viewpoints of improving transmission efficiency that the dielectric layer 7 have a thickness of from 0.1 to 1.6 mm. It is preferred from the viewpoint of improving transmission efficiency that the dielectric layer 7 have a dielectric constant (ε₃) of from 1.0 to 3.0. It is preferred that the present invention be applied to a frequency range of from 1 to 30 GHz, in particular a frequency range from 2 to 6 GHz.

### EXAMPLE

Now, the present invention will be described referring to examples. The present invention is not limited to these examples. It should be noted that various improvement and modifications may be made without departing from the spirit and the scope of the present invention. Now, the examples will be described in detail, referring to the accompanying drawings.

### Example 1

On the assumption that a transmission line transition was fabricated just as shown in FIGS. 1, 2, 3 and 4, transmission characteristics from a pair of conductors 3 for a coplanar strip transmission line to an electromagnetically coupling conductor 10 for a microstrip line were calculated by the FDTD method (Finite Difference Time Domain method). The operating frequency were set at 2.34 GHz. The dimensions of respective parts are shown below, and the frequency characteristics of this example is shown in FIG. 5. In FIG. 5, reference numeral 19 designates reflection loss, and reference numeral 18 designates insertion loss.

| | | |
|---|---|---|
| Dimensions or area of second dielectric | 12.25 × 32.0 | mm (392.0 mm²) |
| substrate 2: | | |
| Thickness of second dielectric | 0.8 | mm |
| substrate 2: | | |
| Thickness of dielectric layer 7: | 0.42 | mm |
| ε₁ | 7.0 | |
| ε₂ | 4.0 | |
| ε₃ | 2.0 | |
| L₁ | 8.0 | mm |
| L₂ | 4.6 | mm |
| L₃ | 21.0 | mm |
| L₄ | 7.0 | mm |
| L₅ | 28.0 | mm |
| W₁ | 1.45 | mm |
| W₂, W₂′ | 0.4 | mm |
| W₃, W₃′ | 0.5 | mm |
| W₄ | 1.0 | mm |
| G₁ | 0.5 | mm |

### Example 2

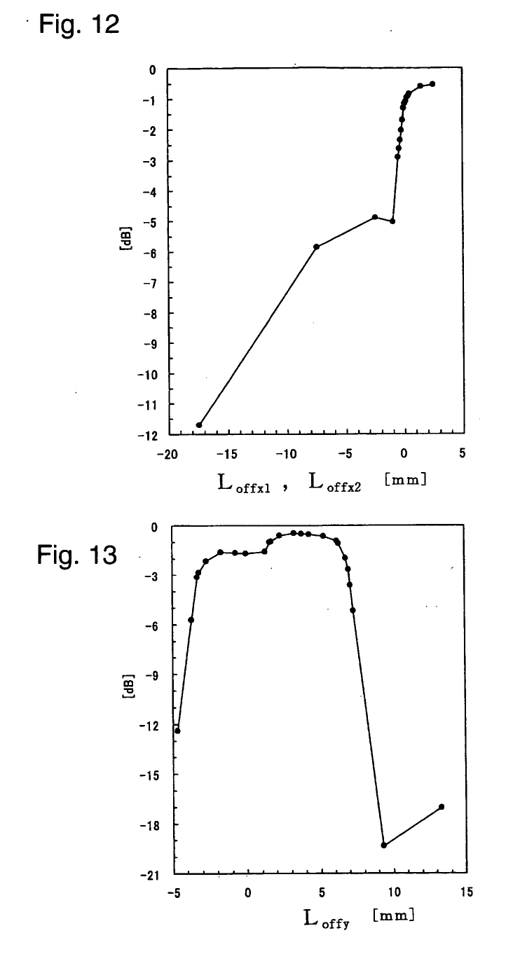

On the assumption that a transmission line transition was fabricated so as to be the same as the one in Example 1 except that L_{offx1} and L_{offx2} were modified, transmission characteristics from a pair of conductors 3 for a coplanar strip transmission line to an electromagnetically coupling conductor 10 for a microstrip line were calculated according to the FDTD method. The operating frequency was set at 2.34 GHz. Characteristics of L_{offx1} to insertion loss, which were obtained when the values of L_{offx1} and L_{offx2} were modified, are shown in FIG. 12.

### Example 3

On the assumption that a transmission line transition was fabricated so as to be the same as the one in Example 1 except that L_{offy} was modified, transmission characteristics from a pair of conductors 3 for a coplanar strip transmission line to an electromagnetically coupling conductor 10 for a microstrip line were calculated according to the FDTD method. The operating frequency was set at 2.34 GHz. Characteristics of L_{offy} to insertion loss, which were obtained when the value of L_{offy} was modified, are shown in FIG. 13.

### Example 4

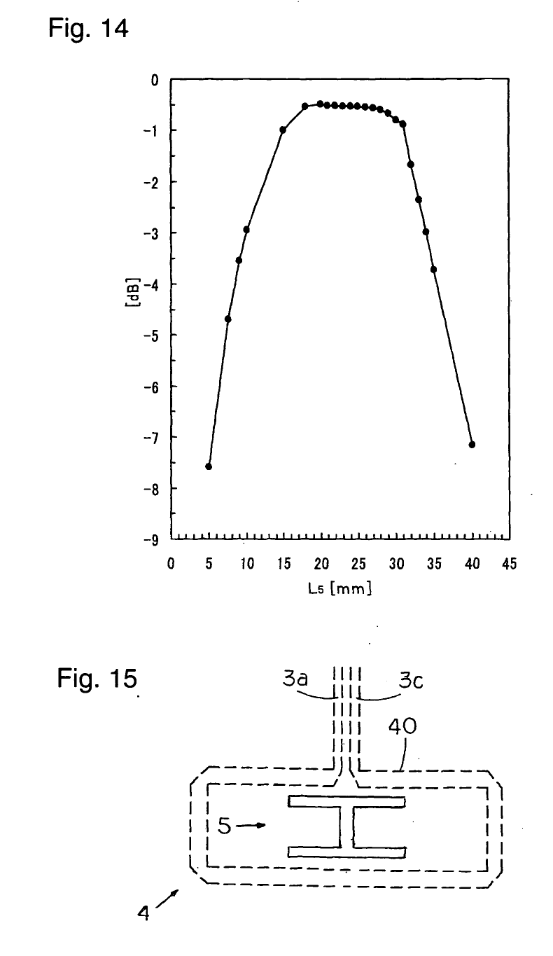

On the assumption that a transmission line transition was fabricated so as to be the same as the one in Example 1 except that the long side width L₅ of an electromagnetically coupling conductor 4 for a coplanar strip transmission line was modified, transmission characteristics from a pair of conductors 3 for the coplanar strip transmission line to an electromagnetically coupling conductor 10 for a microstrip line were calculated according to the FDTD method. The operating frequency was set at 2.34 GHz. Characteristics of length L₅ to insertion loss, which were obtained when the value of the with L₅ was modified, are shown in FIG. 14.

The present invention is applicable to a transmission line transition for a high frequency antenna, which is suitable for use in SDARS, GPS, satellite digital broadcasting, VICS, ETC and DSRC system.

The entire disclosure of Japanese Patent Application No. 2005-73190 filed on Mar. 15, 2005 including specification, claims, drawings and summary is incorporated herein by reference in its entirety.

What is claimed is:

1. A transmission line transition comprising:
a first dielectric substrate;
a second dielectric substrate spaced from the first dielectric substrate;
a dielectric layer interposed between the first dielectric substrate and the second dielectric substrate;
the first dielectric substrate having a pair of conductors for a coplanar strip transmission line and an electromagnetically coupling conductor for the coplanar strip transmission line disposed on a surface close to the dielectric layer;
the electromagnetically coupling conductor for the coplanar strip transmission line being formed in a semi-loop shape with a discontinuity partly formed therein;
respective portions of the electromagnetically coupling conductor for the coplanar strip transmission line, which are located at both ends of the discontinuity or in the vicinity of both ends of the discontinuity, being connected to respective ends of the paired conductors for the coplanar strip transmission line or portions of the paired conductors in the vicinity of the respective ends of the paired conductors, the paired conductors extending toward a direction to be apart from the electromagnetically coupling conductor;
the semi-loop shape being a rectangular shape or a substantially rectangular shape;
the second dielectric substrate having a grounding conductor disposed on a surface close to the dielectric layer, the grounding conductor having a first slot and a second slot formed therein so as to be parallel or substantially parallel to each other;
the grounding conductor further having a connecting slot formed therein so as to connect between the first slot and the second slot so that the first slot, the second slot and the connecting slot form an electromagnetic coupling slot in an H-character shape or substantially H-character shape;
the electromagnetic coupling slot being disposed so that the connecting slot intersects a longitudinal direction of the rectangular shape or the substantially rectangular shape of the semi-loop shape as viewed in a plan view; and
the second dielectric substrate having an electromagnetically coupling conductor for a microstrip transmission line disposed on a surface remote from the dielectric layer so as to pass over or under the connecting slot.

2. A transmission line transition comprising:
a first dielectric substrate;
a second dielectric substrate spaced from the first dielectric substrate;
a dielectric layer interposed between the first dielectric substrate and the second dielectric substrate;
the first dielectric substrate having a pair of conductors for a coplanar strip transmission line and an electromagnetically coupling conductor for the coplanar strip transmission line disposed on a surface close to the dielectric layer;
the electromagnetically coupling conductor for the coplanar strip transmission line being formed in a semi-loop shape with a discontinuity partly formed therein;
respective portions of the electromagnetically coupling conductor for the coplanar strip transmission line, which are located at both ends of the discontinuity or in the vicinity of both ends of the discontinuity, being connected to respective ends of the paired conductors for the coplanar strip transmission line or portions of the paired conductors in the vicinity of the respective ends of the paired conductors, the paired conductors extending toward a direction to be apart from the electromagnetically coupling conductor;
the semi-loop shape being a square shape or a substantially square shape;
the second dielectric substrate having a grounding conductor disposed on a surface close to the dielectric layer, the grounding conductor having a first slot and a second slot formed therein so as to be parallel or substantially parallel to each other;
the grounding conductor further having a connecting slot formed therein so as to connect between the first slot and the second slot so that the first slot, the second slot and the connecting slot form an electromagnetic coupling slot in an H-character shape or substantially H-character shape;
the electromagnetic coupling slot being disposed so that a portion of the connecting slot extending in a longitudinal direction passes over or under a side of the electromagnetically coupling conductor for the coplanar strip transmission line remote from the discontinuity; and
the second dielectric substrate having an electromagnetically coupling conductor for a microstrip transmission line disposed on a surface remote from the dielectric layer so as to pass over or under the connecting slot.

3. The transmission line transition according to claim 1, wherein a portion of the electromagnetic coupling slot is disposed so as to overlap with the electromagnetically coupling conductor for the coplanar strip transmission line as viewed in a plan view.

4. The transmission line transition according to claim 1, wherein when it is assumed that an imaginary straight line extends in a direction perpendicular to a surface of the first dielectric substrate 1 and passes through a center of the connecting slot, and when the center of the connecting slot is viewed from the imaginary straight line, the connecting slot overlaps with a side of the electromagnetically coupling conductor for the coplanar strip transmission line, which is remote from the discontinuity.

5. The transmission line transition according to claim 1, wherein the electromagnetic coupling slot is of such size as to be disposed inside an inner peripheral edge of the electromagnetically coupling conductor for the coplanar strip transmission line as viewed in a plan view;
wherein when it is assumed that an imaginary straight line extends in a direction perpendicular to a surface of the first dielectric substrate and passes through a center of the connecting slot, and when the center of the connecting slot is viewed from the imaginary straight line,
all portions of the electromagnetic coupling slot are disposed inside the inner peripheral edge of the electromagnetically coupling conductor for the coplanar strip transmission line.

6. The transmission line transition according to claim 1, wherein an angle, at which the connecting slot and the electromagnetically coupling conductor for the microstrip transmission line intersect each other as viewed in a plan view, is a right angle or a substantially right angle.

7. The transmission line transition according to claim 1, wherein when it is assumed that an imaginary straight line extends in a direction perpendicular to the first dielectric substrate and passes through a center of the connecting slot, and when the center of the connecting slot is viewed from the imaginary straight line, a point where the connecting slot and the electromagnetically coupling conductor for the microstrip line intersect each other as viewed in a plan view overlaps or substantially overlaps with the center of the connecting slot.

8. The transmission line transition according to claim 1, wherein when it is assumed that an imaginary straight line extends in a direction perpendicular to a surface of the first dielectric substrate and passes through a center of the connecting slot, and when the center of the connecting slot is viewed from the imaginary straight line, the center of the connecting slot overlaps or substantially overlaps with a side of the electromagnetically coupling conductor for the coplanar strip transmission line, which is remote from the discontinuity.

9. The transmission line transition according to claim 1, wherein when it is assumed that an imaginary straight line extends in a direction perpendicular to the first dielectric substrate and passes through a center of the connecting slot, and when the center of the connecting slot is viewed from the imaginary straight line, the center of the connecting slot overlaps or substantially overlaps with a center of a side of the electromagnetically coupling conductor for the coplanar strip transmission line, which is remote from the discontinuity.

10. The transmission line transition according to claim 1, wherein the paired conductors for the coplanar strip transmission line have a narrower conductor width than the electromagnetically coupling conductor for the coplanar strip transmission line.

11. The transmission line transition according to claim 10, wherein the following formula is satisfied:
conductor width of the paired conductors for the coplanar strip transmission line ≦0.6×conductor width of the electromagnetically coupling conductor for the coplanar strip transmission line

12. The transmission line transition according to claim 1, wherein the electromagnetically coupling conductor for the coplanar strip transmission line has a conductor width, and wherein when it is assumed that the electromagnetically coupling conductor for the coplanar strip transmission line has no discontinuity formed therein, and that the electromagnetically coupling conductor for the coplanar strip transmission line is disposed so as to be continuous at a portion with the discontinuity;
the electromagnetically coupling conductor for the coplanar strip transmission line thus assumed has an outer peripheral edge and an inner peripheral edge formed in a square or substantially square shape, respectively.

13. The transmission line transition according to claim 12, wherein in a case that when respective four apexes of the four corners of the square shape or the substantially square shape defined by the outer peripheral edge are called outer peripheral apexes, respective four apexes of the four corners of the square shape or the substantially square shape defined by the inner peripheral edge;
that when it is assumed that a first imaginary straight line connects between at least one of the outer peripheral apexes and an inner peripheral apex closest to the at least one of the outer peripheral apexes, the first imaginary straight line is called a first imaginary line; and
that when it is assumed that a second imaginary straight line extends orthogonally or substantially orthogonally to the first imaginary line and passes through a center or a position in the vicinity of the center between the at least one outer peripheral apex and the inner peripheral apex closest thereto, the second imaginary straight line is called a second imaginary line;
a portion of the electromagnetically coupling conductor for the coplanar strip transmission line, which is located outside the second imaginary line, is cut out.

14. The transmission line transition according to claim 12, wherein the paired conductors for the coplanar strip transmission line comprises a first conductor for the coplanar strip transmission line and a second conductor for the coplanar strip transmission line;
wherein when it is assumed that an outer peripheral edge of a portion of the electromagnetically coupling conductor for the coplanar strip transmission line, which is close to the first conductor for the coplanar strip transmission line and forms one of both end portions of the electromagnetically coupling conductor for the coplanar strip transmission line at both ends of the discontinuity, is linearly extended toward a central portion of the discontinuity, a point where the extended outer peripheral edge intersects an inner peripheral edge of the first conductor for the coplanar strip transmission line is called a first intersection;
wherein when it is assumed that an outer peripheral edge of the first conductor for the coplanar strip transmission line is linearly extended toward the central portion of the electromagnetically coupling conductor for the coplanar strip transmission line, a point where the extended outer peripheral edge of the first conductor intersects an inner peripheral edge of the electromagnetically coupling conductor for the coplanar strip transmission line is called a second intersection; and
wherein when it is assumed that a third imaginary straight line connects between the first intersection and the second intersection, and when the imaginary straight line is called a third imaginary line; a portion of the electromagnetically coupling conductor for the coplanar strip transmission line or the first conductor for the coplanar strip transmission line, which is closer to the central portion of the electromagnetically coupling conductor for the coplanar strip transmission line than the third imaginary line, is cut out.

15. The transmission line transition according to claim 12, wherein the paired conductors for the coplanar strip transmission line comprises a first conductor for the coplanar strip transmission line and a second conductor for the coplanar strip transmission line;
wherein when it is assumed that an outer peripheral edge of a portion of the electromagnetically coupling conductor for the coplanar strip transmission line, which is close to the second conductor for the coplanar strip transmission line and forms one of both end portions of the electromagnetically coupling conductor for the coplanar strip transmission line at both ends of the discontinuity, is linearly extended toward a central portion of the discontinuity, a point where the extended outer peripheral edge intersects an inner peripheral edge of the second conductor for the coplanar strip transmission line is called a third intersection;
wherein when it is assumed that a portion of the outer peripheral edge of the second conductor for the coplanar strip transmission line is linearly extended toward the central portion of the electromagnetically coupling conductor for the coplanar strip transmission line, a point where the extended outer peripheral edge of the second conductor intersects an inner peripheral edge of the electromagnetically coupling conductor for the coplanar strip transmission line is called a fourth intersection; and
wherein when it is assumed that a fourth imaginary straight line connects between the third intersection and the fourth intersection, and when the fourth imaginary straight line is called a fourth imaginary line, a portion of the electromagnetically coupling conductor for the coplanar strip transmission line or the second conductor for the coplanar strip transmission line, which is closer to the central portion of the electromagnetically coupling conductor for the coplanar strip transmission line than the fourth imaginary line, is cut out.

16. The transmission line transition according to claim 1, which has an operating frequency of from 1.95 to 2.93 GHz; and
wherein the electromagnetically coupling conductor for the coplanar strip transmission line has a side opposite the discontinuity, the side having a length L₅ of from 5.0 to 46.1 mm.

17. The transmission line transition according to claim 16, wherein the electromagnetically coupling conductor for the coplanar strip transmission line has two sides adjacent the side opposite the discontinuity, the two sides having a length L₄ of from 5.0 to 46.1 mm.

18. The transmission line transition according to claim 16, wherein the following formula is satisfied:
1.1×length L₄≦length L₅

19. The transmission line transition according to claim 1, which has an operating frequency of from 1.95 to 2.93 GHz; and
wherein the paired conductors for the coplanar strip transmission line comprises a first conductor for the coplanar strip transmission line and a second conductor for the coplanar strip transmission line, and the first conductor for the coplanar strip transmission line and the second conductor for the coplanar strip transmission line have a gap for the coplanar strip transmission line interposed therebetween;
wherein in a case that when it is assumed that an imaginary straight line passes a center of the gap for the coplanar strip transmission line and extends toward a side of a center of the electromagnetically coupling conductor for the coplanar strip transmission line, the electromagnetically coupling conductor for the coplanar strip transmission line is viewed, being divided into a portion close to the first conductor for the coplanar strip transmission line and a portion close to the second conductor for the coplanar strip transmission line, with the imaginary straight line used as a boundary;
when an inner edge of a side of the electromagnetically coupling conductor for the coplanar strip transmission line, which forms one of two sides adjacent a side opposite the discontinuity and is close to the first conductor for the coplanar strip transmission line, is called a first inner edge;
when an inner edge of a side of the electromagnetically coupling conductor for the coplanar strip transmission line, which forms the other one of the two sides adjacent the side opposite the discontinuity and is close to the second conductor for the coplanar strip transmission line, is called a second inner edge;
when a leading edge of the first slot, which is close to the first inner edge, is called a first leading edge of the first slot;
when a leading edge of the first slot, which is close to the second inner edge, is called a second leading edge of the first slot;
when a leading edge of the second slot, which is close to the first inner edge, is called a first leading edge of the second slot;
when a leading edge of the second slot, which is close to the second inner edge, is called a second leading edge of the second slot;
when a shorter one of a shortest distance between the first leading edge of the first slot and the first inner edge, and a shortest distance between the first leading edge of the second slot and the first inner edge is called L_{offx1}; and
when a shorter one of a shortest distance between the second leading edge of the first slot and the second inner edge, and a shortest distance between the second leading edge of the second slot and the second inner edge is called L_{offx2};
the following formulas are satisfied:
L_{offx1}≧−2 mm and L_{offx2}≧−2 mm
wherein it is determined that a value of L_{offx1} is positive when the first leading edge of the first slot approaches toward the center of the electromagnetically coupling conductor for the coplanar strip transmission line in a direction, which is parallel to the longitudinal direction of the side of the electromagnetically coupling conductor for the coplanar strip transmission line remote from the discontinuity, and that the value of L_{offx1} is negative when the first leading edge of the first slot recedes from the center in the direction; and
wherein it is determined that a value of L_{offx2} is positive when the second leading edge of the first slot approaches toward the center of the electromagnetically coupling conductor for the coplanar strip transmission line in a direction, which is parallel to the longitudinal direction of the side of the electromagnetically coupling conductor for the coplanar strip transmission line remote from the discontinuity, and that the value of L_{offx2} is negative when the second leading edge of the first slot recedes from the center in the direction.

20. The transmission line transition according to claim 2, which has an operating frequency of from 1.95 to 2.93 GHz; and
wherein the paired conductors for the coplanar strip transmission line comprises a first conductor for the coplanar strip transmission line and a second conductor for the coplanar strip transmission line, and the first conductor for the coplanar strip transmission line and the second conductor for the coplanar strip transmission line have a gap for the coplanar strip transmission line interposed therebetween;
wherein in a case that when it is assumed that an imaginary straight line passes a center of the gap for the coplanar strip transmission line and extends toward a center of the electromagnetically coupling conductor for the coplanar strip transmission line, the electromagnetically coupling conductor for the coplanar strip transmission line is viewed, being divided into a portion close to the first conductor for the coplanar strip transmission line and a portion close to the second conductor for the coplanar strip transmission line, with the imaginary straight line used as a boundary;
when an inner edge of a side of the electromagnetically coupling conductor for the coplanar strip transmission line, which forms one of two sides adjacent a side opposite the discontinuity and is close to the first conductor for the coplanar strip transmission line, is called a first inner edge;
when an inner edge of a side of the electromagnetically coupling conductor for the coplanar strip transmission line, which forms the other one of the two sides adjacent the side opposite the discontinuity and is close to the second conductor for the coplanar strip transmission line, is called a second inner edge;
when a leading edge of the first slot, which is close to the first inner edge, is called a first leading edge of the first slot;
when a leading edge of the first slot, which is close to the second inner edge, is called a second leading edge of the first slot;
when a leading edge of the second slot, which is close to the first inner edge, is called a first leading edge of the second slot;
when a leading edge of the second slot, which is close to the second inner edge, is called a second leading edge of the second slot;
when a shorter one of a shortest distance between the first leading edge of the first slot and the first inner edge, and a shortest distance between the first leading edge of the second slot and the first inner edge is called L_{offx1}; and
when a shorter one of a shortest distance between the second leading edge of the first slot and the second inner edge, and a shortest distance between the second leading edge of the second slot and the second inner edge is called L_{offx2};
the following formulas are satisfied:
L_{offx1}≧−2 mm and L_{offx2}≧−2 mm
wherein it is determined that a value of L_{offx1} is positive when the first leading edge of the first slot approaches toward the center of the electromagnetically coupling conductor for the coplanar strip transmission line in a direction, which is parallel to the longitudinal direction of the side of the electromagnetically coupling conductor for the coplanar strip transmission line remote from the discontinuity, and that the value of L_{offx1} is negative when the first leading edge of the first slot recedes from the center in the direction; and
wherein it is determined that a value of L_{offx2} is positive when the second leading edge of the first slot approaches toward the center of the electromagnetically coupling conductor for the coplanar strip transmission line in a direction, which is parallel to the longitudinal direction of the side of the electromagnetically coupling conductor for the coplanar strip transmission line remote from the discontinuity, and that the value of L_{offx2} is negative when the second leading edge of the first slot recedes from the center in the direction.

21. The transmission line transition according to claim 1, wherein when a distance between an outer edge of a side of the electromagnetically coupling conductor for the coplanar strip transmission line close to the paired conductors for the coplanar strip transmission line and an edge of the first slot close to the connecting slot is called L_{offy}, the formula is satisfied:
−4.3 mm≦L_{offy}≦8.0 mm
wherein it is determined that a value of L_{offy} is positive when the edge of the first slot close to the connecting slot is disposed so as to be close to the side of the electromagnetically coupling conductor for the coplanar strip transmission line remote from the discontinuity with the outer edge of the side of the electromagnetically coupling conductor for the coplanar strip transmission line close to the paired conductors for the coplanar strip transmission line used as the boundary, and that the value of L_{offy} is negative when the edge of the first slot is disposed so as to be close to the paired conductors for the coplanar strip transmission line.

22. The transmission line transition according to claim 2, wherein when a distance between an outer edge of a side of the electromagnetically coupling conductor for the coplanar strip transmission line close to the paired conductors for the coplanar strip transmission line and an edge of the first slot close to the connecting slot is called L_{offy}, the formula is satisfied:
−4.3 mm≦L_{offy}≦8.0 mm
wherein it is determined that a value of L_{offy} is positive when the edge of the first slot close to the connecting slot is disposed so as to be close to the side of the electromagnetically coupling conductor for the coplanar strip transmission line remote from the discontinuity 4a with the outer edge of the side of the electromagnetically coupling conductor for the coplanar strip transmission line close to the paired conductors for the coplanar strip transmission line used as the boundary, and that the value of L_{offy} is negative when the edge of the first slot is disposed so as to be close to the paired conductors for the coplanar strip transmission line.

23. The transmission line transition according to claim 1, wherein the electromagnetically coupling conductor for the coplanar strip transmission line has a short side and a long side, and wherein when the short side has a length L₄ and the long side has a length L₅,
the formula of 0.11≦(L₄/L₅)<1.0 is satisfied.

24. The transmission line transition according to claim 2, wherein the electromagnetically coupling conductor for the coplanar strip transmission line has a short side and a long side, and wherein when the short side has a length L₄ and the long side has a length L₅,
the formula of 0.11≦(L₄/L₅)<1.0 is satisfied.

25. The transmission line transition according to claim 1, wherein the first dielectric substrate has a thickness of from 2.0 to 6.0 mm and a dielectric constant of from 5.0 to 9.0;
wherein the second dielectric substrate has a thickness of from 0.1 to 6.0 mm and a dielectric constant of from 1.0 to 8.0; and
wherein the dielectric layer has a thickness of from 0.1 to 1.6 mm and a dielectric constant of from 1.0 to 3.0.
